(19) United States
(12) Patent Application Publication
(10) Pub. No.: US 2012/0246402 A1
(43) Pub. Date: Sep. 27, 2012

(54) COMMUNICATION DEVICE, COMMUNICATION METHOD, AND COMPUTER- READABLE RECORDING MEDIUM STORING PROGRAM

(75) Inventor: Shunsuke AKIMOTO, Tokyo (JP)

(73) Assignee: NEC Corporation, Tokyo (JP)

(21) Appl. No.: 13/429,140

(22) Filed: Mar. 23, 2012

(30) Foreign Application Priority Data
Mar. 25, 2011 (JP) 2011-068271

(51) Int. Cl. G06F 12/08

(52) U.S. Cl. 711/113; 711/E12.019

(57) ABSTRACT

A communication device reducing the processing time to install data on a disc storage medium onto multiple servers is provided. A protocol serializer 10 of a communication device 5 serializes read requests received from servers A1 to A2 for target data stored on a disc storage medium K in a processing order. A cache controller 11 determines whether the target data corresponding to the read requests are present in a cache memory 4 in the order of serialized read requests and, if present, receives the target data from the cache memory 4 via a memory controller 12. If not present, the cache controller 11 acquires the target data from the disc storage medium K via a DVD/CD controller 13. Then, the protocol serializer 10 sends the target data acquired by the cache controller 11 to the server of the transmission source of the read request corresponding to the target data.

### CROSS-REFERENCE TO RELATED APPLICATION

The present application claims the benefit of Japanese Patent Application 2011-068271, filed on Mar. 25 2011, the entire disclosure of which is incorporated by reference herein

### FIELD

The present application relates to a communication device, communication method, and computer-readable recording medium storing programs.

### BACKGROUND

In recent years, techniques for controlling access to data storage media have been proposed. For example, Unexamined Japanese Patent Application Kokai Publication No. 2000-194680 discloses a technique for serializing access to a main storage from processors in a multiprocessor system comprising multiple processors. The term “serializing” means that when multiple entities simultaneously make an access request to a source incapable of simultaneously receiving access from multiple entities, adjustment is made so that the entities can use the source in turn.

Unexamined Japanese Patent Application Kokai Publication No. 2000-194680 discloses a technique for temporarily storing data to be written on a recording medium in a cache memory and writing the stored data on the recording medium on the basis of a group of a given address range. Unexamined Japanese Patent Application Kokai Publication No. H9-325905 discloses a technique for converting write and read requests issued by multiple computers having different interfaces so that the computers can share data on a storage medium. Unexamined Japanese Patent Application Kokai Publication No. H10-079666 discloses a technique for postponing the processing of a write request if a client is reading data from a CD-R disc and, in the meantime, a write request is made by another client so that the client can read the latest data.

### SUMMARY

A disc storage medium inserted in an optical drive can be accessed by only one machine. Therefore, in installing software such as an OS (operating system) on multiple machines, data are installed on one machine and then on another machine. Therefore, it takes a long time to complete the installation on all machines. Regarding this problem, for example, the Unexamined Japanese Patent Application Kokai Publication No. H10-079666 allows one client to read data on a CD-R disc; and there is no consideration of multiple machines reading data on a CD-R disc. Therefore, this technique does not solve the above problem.

The present invention has been invented in view of the above circumstances and an exemplary objective of the present invention is to provide a communication device, communication method, and program for reducing the processing time for installing data on a disc storage medium to multiple servers.

The communication device according to a first exemplary aspect of the present invention comprises:

a receiver receiving read requests for data stored disc storage medium from multiple servers;

a serializer arranging the read requests received by the receiver in a processing order;

a writer writing data stored on the disc storage medium in a cache memory;

a determiner determining whether the target data corresponding to the read requests are present in the cache memory in the order of the read requests arranged by the serializer;

an information acquirer acquiring the target data from the cache memory when the determiner determines that the target data are present in the cache memory, and acquiring the target data from the disc storage medium when the determiner determines that the target data are not present in the cache memory; and

a transmitter sending the target data acquired by the information acquirer to the server of the transmission source of the read request corresponding to the target data.

The communication method according to a second exemplary aspect of the present invention comprises:

a reception step of receiving read requests for data stored on a disc storage medium from multiple servers;

a serialization step of arranging the read requests received in the reception step in a processing order;

a writing step of writing data stored on the disc storage medium in a cache memory;

a determination step of determining whether the target data corresponding to the read requests are present in the cache memory in the order of the read requests arranged in the serialization step;

an information acquisition step of acquiring the target data from the cache memory when it is determined that the target data are present in the cache memory in the determination step, and acquiring the target data from the disc storage medium when it is determined that the target data are not present in the cache memory; and

a transmission step of sending the target data acquired in the information acquisition step to the server of the transmission source of the read request corresponding to the target data.

The program stored on a computer-readable recording medium according to a third exemplary aspect of the present invention allows a computer to function as:

a receiver receiving read requests for data stored on a disc storage medium from multiple servers;

a serializer arranging the read requests received by the receiver in a processing order;

a writer writing data stored on the disc storage medium in a cache memory;

a determiner determining whether the target data corresponding to the read requests are present in the cache memory in the order of the read requests arranged by the serializer;

an information acquirer acquiring the target data from the cache memory when the determiner determines that the target data are present in the cache memory, and acquiring the target data from the disc storage medium when the determiner determines that the target data are not present in the cache memory; and

a transmitter sending the target data acquired by the information acquirer to the server of the transmission source of the read request corresponding to the target data.

The present invention allows servers to simultaneously access data stored on a disc storage medium, reducing the processing time to install data on a disc storage medium onto multiple servers.

### BRIEF DESCRIPTION OF THE DRAWINGS

A more complete understanding of The present application can be obtained when the following detailed description is considered in conjunction with the following drawings, in which:

FIG. 1 is a block diagram showing an exemplary configuration of the communication system according to an embodiment of the present invention;

FIG. 2 is an illustration showing an exemplary read request packet sent by servers;

FIG. 3 is a block diagram showing the configuration of the protocol serializer;

FIG. 4 is a diagram for explaining the procedure executed by the protocol serializer on read request packets;

FIG. 5 is an illustration showing an exemplary read request packet sent to the cache controller;

FIG. 6 is a block diagram showing the configuration of the cache controller;

FIG. 7 is an illustration showing an exemplary cache table;

FIG. 8 is a diagram for explaining the procedure executed by the cache controller on read request packets after the procedure in FIG. 4;

FIG. 9 is an illustration showing an exemplary target data packet;

FIG. 10 is a diagram for explaining the procedure executed by the cache controller on target data packets after the procedure in FIG. 8;

FIG. 11 is a diagram showing the procedure executed by the protocol serializer on target data packets after the procedure in FIG. 10;

FIG. 12 a chart for explaining the entire operation of the communication system when the target data corresponding to a read request are present in the cache memory;

FIG. 13 a chart for explaining the entire operation of the communication system when the target data corresponding to a read request are not present in the cache memory;

FIG. 14 is a chart for explaining the entire operation of the communication system when a disc storage medium is inserted in the DVD/CD drive;

FIG. 15 is a chart for explaining the entire operation of the communication system when the disc storage medium is removed from the DVD/CD drive; and

FIG. 16 an illustration showing an exemplary modified cache table.

### DETAILED DESCRIPTION

An embodiment of the present invention will be described hereafter with reference to the drawings. In the figures, the same or equivalent components are referred to by the same reference numbers.

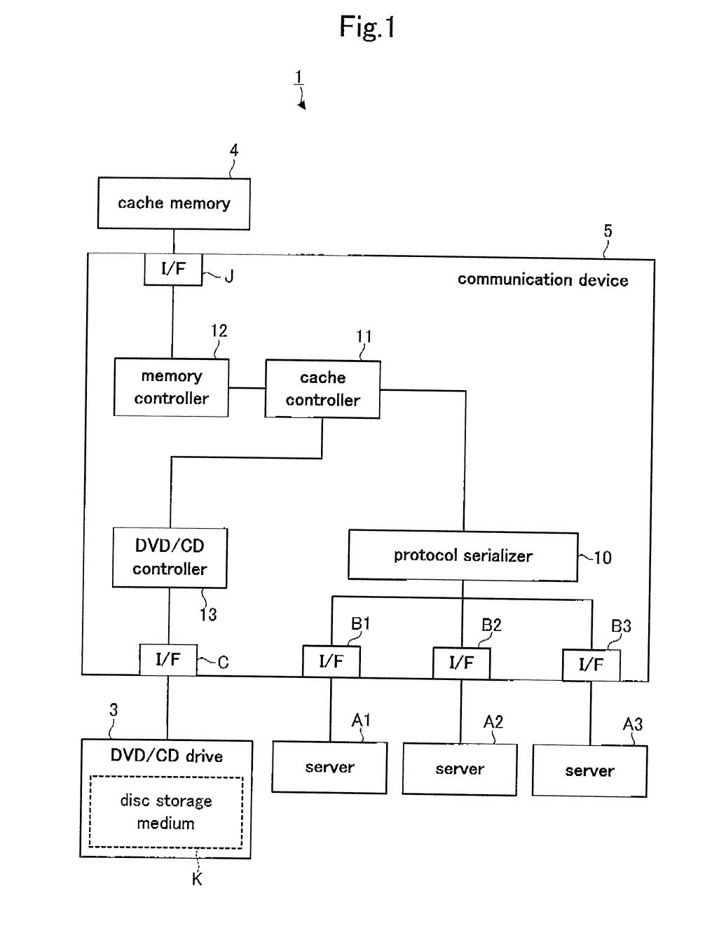

FIG. 1 is a block diagram showing an exemplary configuration of a communication system 1 according to an embodiment of the present invention. The communication system 1 comprises multiple servers A1 to A3, a DVD/CD drive 3, a cache memory 4, and a communication device 5.

The DVD/CD drive 3 is a drive into which a disc storage medium K such as a CD-ROM disc, CD-R disc, CD-RW disc, DVD-ROM disc, DVD-R disc, DVD-RW disc, DVD-RAM disc, DVD+RW disc, and DVD+R disc is inserted. The DVD/CD drive 3 allows a single device to access the disc storage medium K and read data stored on the disc storage medium K.

The cache memory 4 consists of a single or multiple DIMMs (dual inline memory modules) and is used to write data stored on the disc storage medium K therein. The cache memory 4 has a capacity equal to or larger than the maximum capacity of a disc storage medium K inserted in the DVD/CD drive 3. The cache memory 4 can be accessed by multiple devices simultaneously.

The servers A1 to A3 each have a control part, storage, and communication part (not shown). The control part of the servers A1 to A3 makes the communication part send a read request to the communication device 5. Furthermore, the control part makes the communication part receive target data returned in response to the read request and store them in the storage.

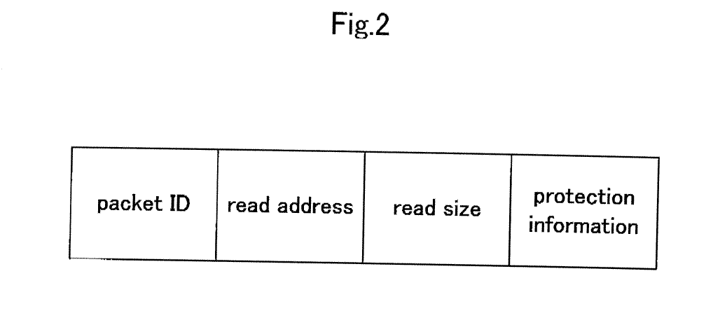

FIG. 2 is an illustration showing an exemplary read request packet sent by the servers A1 to A3. A read request packet contains a packet ID, a read address, a read size, and protection information. The packet ID is an ID identifying the read request packet. The read address presents an address on a disc storage medium K where target data are stored. The read size presents the size of the target data. The protection information is information for protectin packet.

The communication device 5 is a device relaying communication between the severs A1 to A3 and DVD/CD drive 3, comprising, as shown in FIG. 1, a protocol serializer 10, a cache controller 11, a memory controller 12, a DVD/CD controller 13, server interfaces 31 to B3, a DVD/CD drive interface C, and a memory interface J.

The server interfaces B1 to B3 are provided for the servers A1 to A3, respectively. Each server interface B is an interface for connecting the corresponding server A to the communication device 5 and consists of, for example, an USB (universal serial bus) 2.0, USB 1.1, ATA (advanced technology attachment), or SATA (serial advanced technology attachment).

The DVD/CD drive interface C is an interface for connecting the DVD/CD drive 3 to the communication device 5 and, like the sever interface B, consists of a USB 2.0, USB 1.1, ATA, or SATA.

In this embodiment, the server interface B and DVD/CD drive interface C are of the same kind. Here, the interfaces B and C can be of different kinds. In such a case, interface conversion device is provided to the communication device 5.

The memory interface J is an interface for connecting the cache memory 4 to the communication device 5 and consists of, for example, a DDR (double data rate) 2/DDR 3.

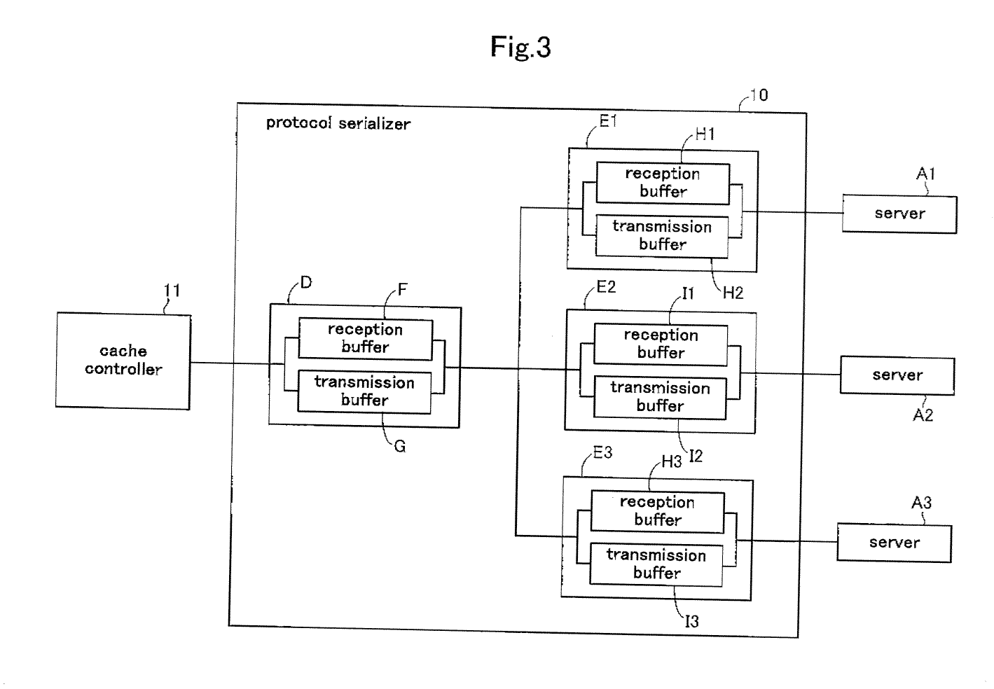

FIG. 3 is a block diagram showing the configuration of the protocol serializer 10. The protocol serializer 10 comprises a drive transmission/reception buffer D and server transmission/reception buffers E1 to E3. The drive transmission/reception buffer D includes a reception buffer F and a transmission buffer G. The server transmission/reception buffers E1 to E3 are provided for the servers A1 to A3, respectively. Each server transmission/reception buffer E includes a reception buffer H and a transmission buffer I.

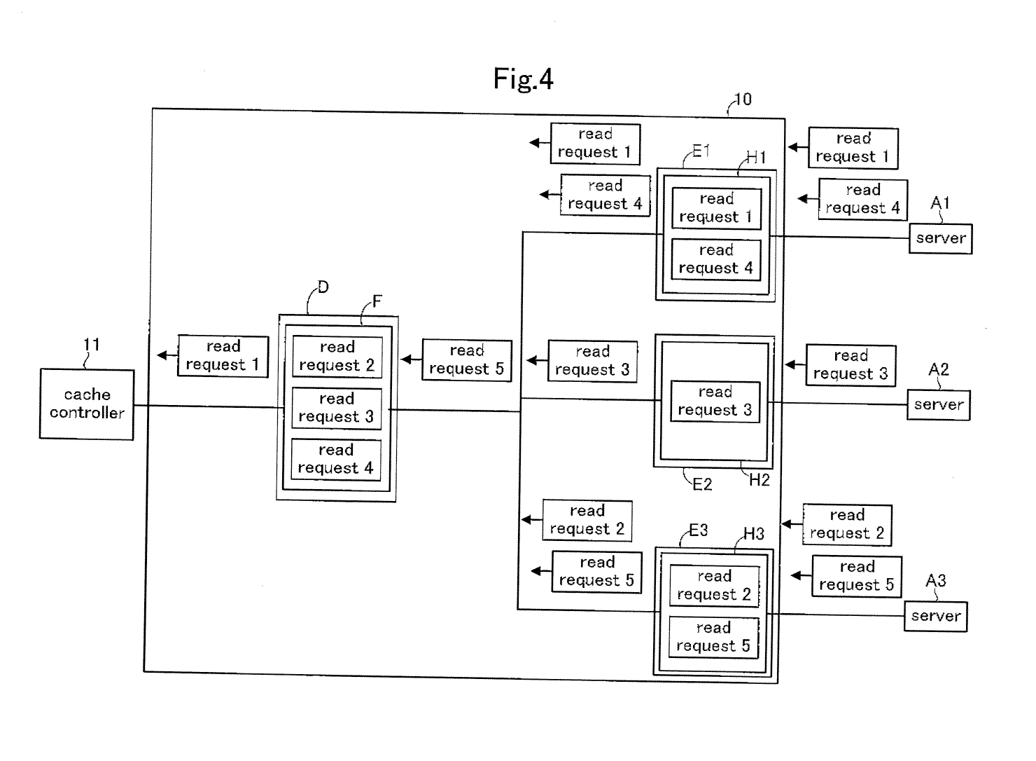

FIG. 4 is a diagram for explaining the procedure executed by the protocol serializer 10 on read request packets.

The protocol serializer 10 makes the reception buffers H1 to H3 of the server transmission/reception buffers E1 to E3 receive and store read request packets sent from the servers A1 to A3 via the server interfaces B1 to B3 (FIG. 1).

In the example of FIG. 4, sent from the server A1, packets of read request 1 and 4 are received by and accumulated in the reception buffer H1 in the server transmission/reception buffer E1. Sent from the server A2, a packet of read request 3 is received by and accumulated in the reception buffer H2 in the server transmission/reception buffer E2. Sent from the server A3, packets of read requests 2 and 5 are received by and accumulated in the reception buffer H3 in the server transmission/reception buffer E3.

Furthermore, the protocol serializer 10 serializes the read request packets received from the servers A1 to A3 and sends them to the cache controller 11. More specifically, the protocol serializer 10 retrieves the read request packets received by and accumulated in the reception buffers H1 to H3 in the order of reception, stores them in the reception buffer F in the drive transmission/reception buffer D, retrieves the stored read request packets in the FIFO (first-in first-out) manner, and sends them to the cache controller 11. In the example of FIG. 4, the packets of read requests 1 to 5 are retrieved from the reception buffers H1 to H3 and stored in the reception buffer F in the order of reception of read requests 1→2→3→4→5, and sent to the cache controller 11 in the order of storage.

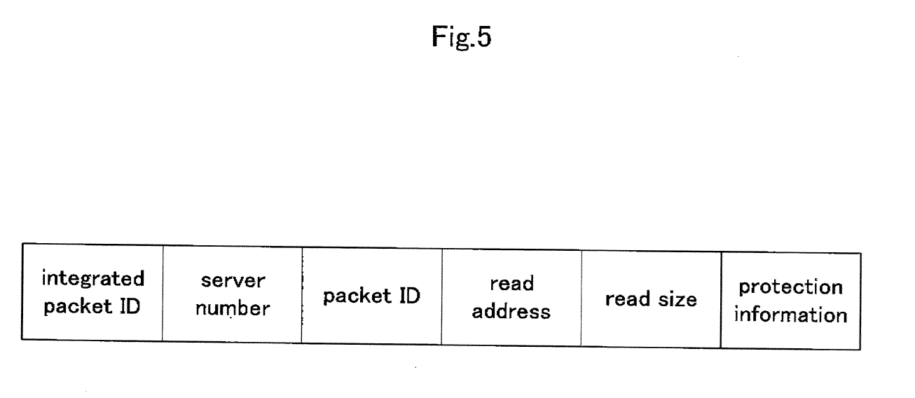

FIG. 5 is an illustration showing an exemplary read request packet sent to the cache controller 11. The read request packet shown in FIG. 5 has an integrated packet ID and a server number in addition to the read request packet shown in FIG. 2. The integrated packet ID is unique identification information within the communication device 5 and serves as the packet header information. The server number presents the transmission source server A of the read request. The integrated packet ID and server number are added by the protocol serializer 10 when the read request is stored in the reception buffer F. For example, the server number indicating the server A1 is added to the packet of read request 1 stored in the reception buffer H1.

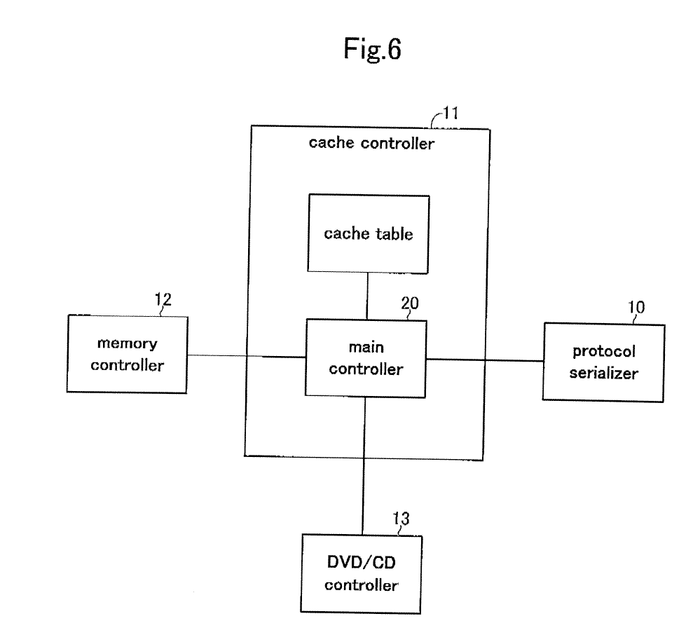

FIG. 6 is a block diagram showing the configuration of the cache controller 11. The cache controller 11 comprises a main controller 20 and stores a cache table.

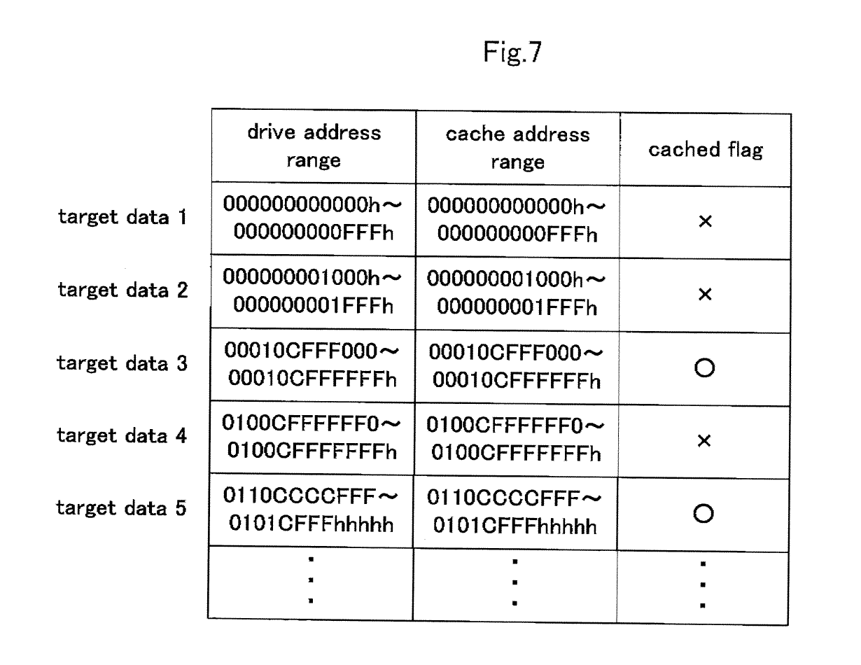

FIG. 7 is an illustration showing an exemplary cache table. The cache table associates a drive address range, a cache address range, and a cached flag with one another. The drive address range presents a range of addresses on a disc storage medium K at which the target data corresponding to a read request are stored. The cache address range presents a range of addresses in the cache memory 4 at which the target data corresponding to a read request are stored. In this embodiment, the drive address range and cache address range in each row of the cache table are the same.

The cached flag indicates whether the data stored in the drive address r of the disc storage medium K have already been written (cached) in the cache address range of the cache memory 4. In the rows having a cached flag “o,” the data stored in the drive address range have already been written in the cache address range. In the rows having a cached flag “x,” data stored in the drive address range have not been written in the cache address range.

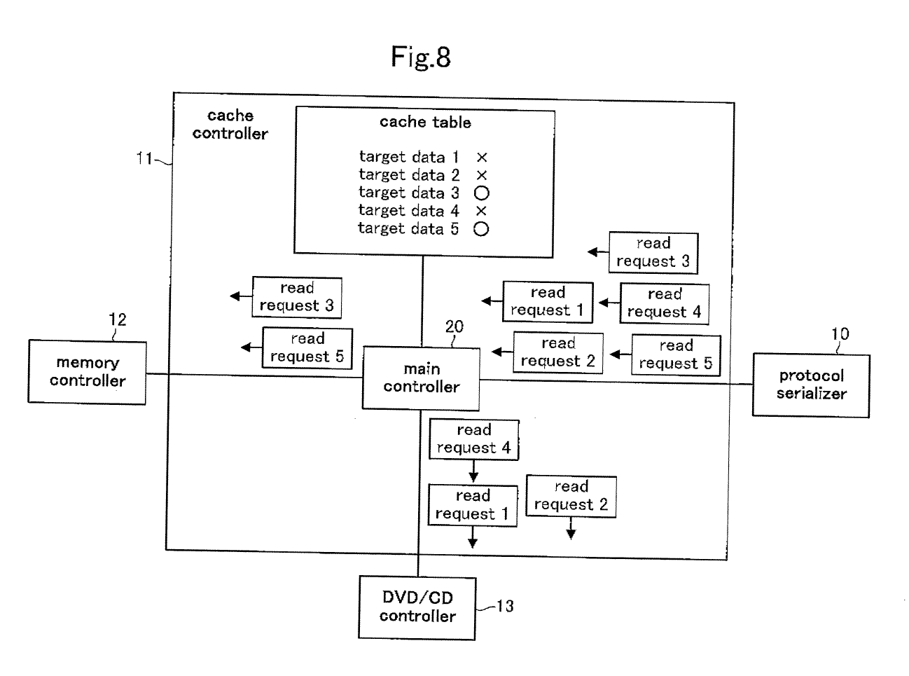

FIG. 8 is a diagram for explaining the procedure executed by the cache controller 11 on read request packets after the procedure in FIG. 4.

When the cache controller 11 receives a read request packet, the main controller 20 makes reference to the cache table and determines whether the target data corresponding to the read request are present in the cache memory 4 (FIG. 1). More specifically, the main controller 20 identifies the row of the cache table having a drive address range or cache address range equal to the read address presented in the read request packet and determines that the target data are present in the cache memory 4 if the row has a cached flag “o” and that the target data are not present in the cache memory 4 if the row has a cached flag “x.”

The main controller 20 sends the read request packet for which it is determined that the target data are present in the cache memory 4 to the memory controller 12, and the read request packet for which it is determined that the target data are not present in the cache memory 4 to the DVD/CD controller 13.

The rows 3 and 5 in the cache table (FIG. 7) are the rows presenting the addresses where the target data 3 and 4 of the read requests 3 and 5 are stored, respectively, and their cached flag is “o.” Therefore, it is determined that the target data 3 and 5 are present in the cache memory 4 and, consequently, the packets of read requests 3 and 5 are sent to the memory controller 12 as shown in FIG. 8.

The rows 1, 2, and 4 in the cache table (FIG. 7) are the rows presenting the addresses where the target data 1, 2, and 4 of the read requests 1, 2, and 4 are stored, respectively, and their cached flag is “x.” Therefore, it is determined that the target data 1, 2, and 4 are not present in the cache memory 4 and, consequently, the packets of read requests 1, 2, and 4 are sent to the DVD/CD controller 13.

In this embodiment, the determination as to whether the target data are present/absent in the cache memory 4 and the transmission of read request packets based on the determination results are conducted each time a read request packet is received from the protocol serializer 10. Consequently, the read request packets are sent to the DVD/CD controller 13 or to the memory controller 12 in the order of serialization by the protocol serializer 10. In the example of FIG. 8, the read requests 1 to 5 are serialized in the order of read requests 1→2→3→4→5. Therefore, the packets of read requests 3 and 5 are sent to the memory controller 12 in the order of read requests 3→5. The packets of read requests 1, 2, and 4 are sent to the DVD/CD controller 13 in the order of read requests 1→2→4.

The memory controller 12 is capable of writing data in the cache memory 4 and reading data from the cache memory 4 via the memory interface J (FIG. 1). Each time the memory controller 12 receives a read request packet from the cache controller 11, the memory controller 12 reads target data from the cache memory 4 according to the contents of the packet (read address and read size), generates a packet of the target data, and sends it to the cache controller 11.

The DVD/CD controller 13 is capable of reading data on the disc storage medium K via the DVD/CD drive interface C (FIG. 1). Each time the DVD/CD controller 13 receives a read request packet from the cache controller 11, the DVD/CD controller 13 reads target data from the disc storage medium K according to the contents of the packet, generates a packet of the target data, and sends it to the cache controller 11.

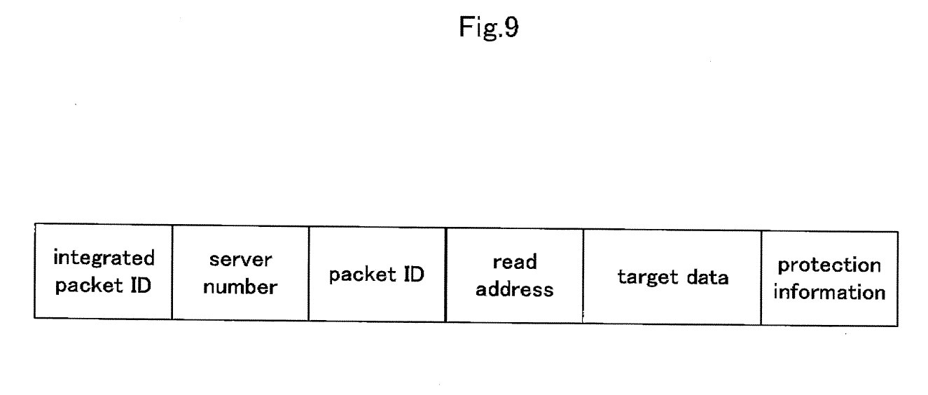

FIG. 9 is an illustration showing an exemplary target data packet sent from the memory controller 12 or DVD/CD controller 13. A target data packet has an integrated packet ID, a server number, a packet ID, a read address, and protection information in addition to the target data read from the cache memory 4 or from the disc storage medium K. The integrated packet ID, server number, packet ID, read address, and protection information are those contained in the read request packet (FIG. 5).

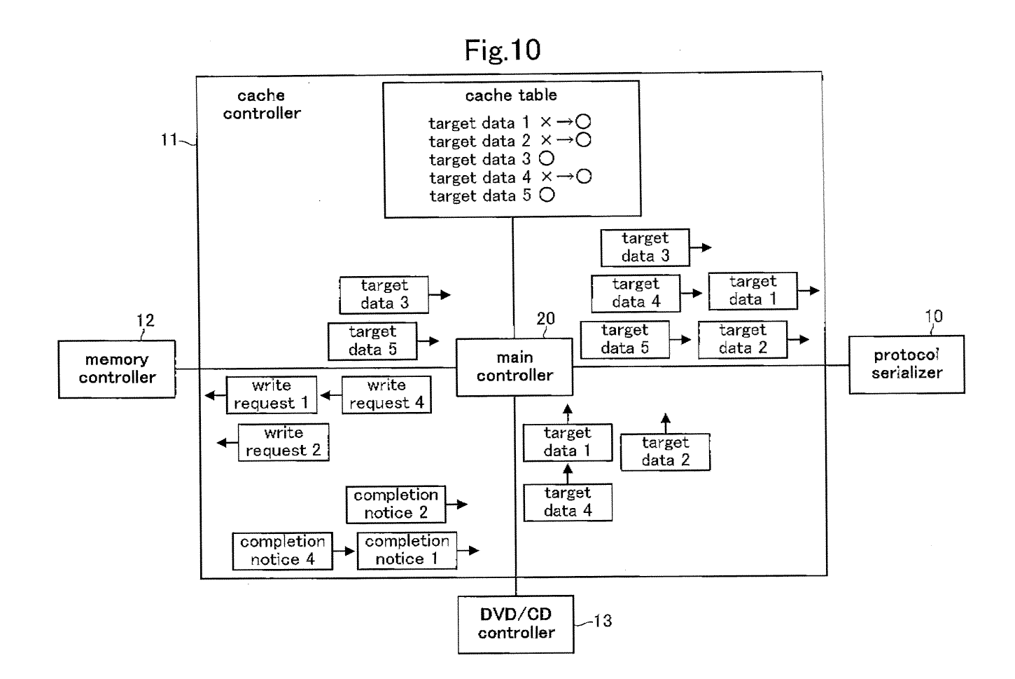

FIG. 10 is a diagram for explaining the procedure executed by the cache controller 11 on target data packets after the procedure in FIG. 8.

As described above, as the memory controller 12 or DVD/CD controller 13 reads target data from the cache memory 4 or disc storage medium K and sends a target data packet to the cache controller 11, the cache controller 11 acquires the target data corresponding to a read request among the data stored on the disc storage medium K (including not only the data stored on the disc storage medium K itself but also the data written in the cache memory 4).

Furthermore, each time the memory controller 12 or DVD/CD controller 13 receives a read request packet, the memory controller 12 or DVD/CD controller 13 reads the target data and sends them to the cache controller 11. Then, the cache controller 11 acquires the target data corresponding to read requests in the order of the read requests serialized by the protocol serializer 10. In the example of FIG. 10, the cache controller 11 acquires the target data 1 to 5 of the read requests 1 to 5 in the order of the serialized read requests 3→5, 1→2→4.

Each time the cache controller 11 receives a target data packet (of the target data 3 and 5 in FIG. 10) from the memory controller 12, the main controller 20 sends the target data packet to the protocol serializer 10.

Furthermore, each time the cache controller 11 receives a target data packet from the DVD/CD controller 13, the main controller 20 sends a request to write the target data to the memory controller 12. In the example of FIG. 10, when the packets of the target data 1, 2, and 4 are received, requests 1, 2, and 4 to write the target data 1, 2, and 4 are sent to the memory controller 12.

A write request is sent to the memory controller 12 to write target data in the cache memory 4. A write request at least contains the target data and read address of a target data packet (FIG. 9). In this embodiment, a target data packet (FIG. 9) received from the DVD/CD controller 13 is transferred to the memory controller 12 as it is as a write request As described above, the read address is contained in a write request (a target data packet) with the intension of storing the target data at the same address in the cache memory 4 and on the disc storage medium K. Consequently, the drive address range and cache address range in the cache table (FIG. 7) are the same.

Each time the memory controller 12 receives a write request from the cache controller 11, the memory controller 12 writes the target data contained in the write request in the cache memory 4. The address at which the target data are written is set to the read address contained in the write request.

After the target data are written, the memory controller 2 sends a notice of completion of writing to the cache controller 11. The completion notice at least contains the address in the cache memory 4 at which the target data are written (namely, the read address).

Each time the cache controller 11 receives a completion notice, the main controller 20 records information indicating the completion of writing target data in the cache table (FIG. 7). More specifically, the main controller 20 identifies the row of the cache table having an address in the cache address range (or drive address range) equal to the address contained in the completion notice, and changes the cached flag in that row from “x” to “o.” In the example of FIG. 10, receiving the notices of completion 1, 2, and 4 from the memory controller 12, the cached flag in the rows of the target data 1, 2, and 4 in the cache table is changed from “x” to “o.”

After the cache table recording (flag change) is completed, the main controller 20 sends the packets of target data (the target data 1, 2, and 4 in FIG. 10) received from the DVD/CD controller 13 to the protocol serializer 10.

In the example of FIG. 10, the target data are sent from the main controller 20 to the protocol serializer 10 in the order of target data 1→2→3→4→5. However, as described above, target data not present in the cache memory 4 and target data present in the cache memory 4 are treated differently; then, the target data 1, 2, and 4 and the target data 3 and 5 may be sent in a switched order.

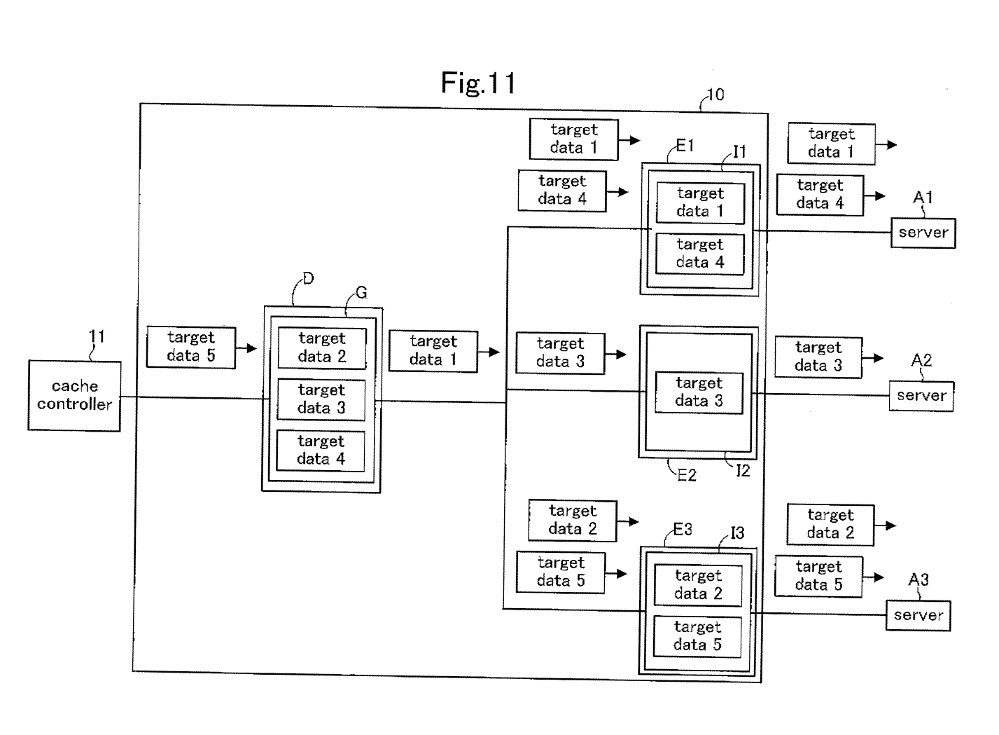

FIG. 11 is a diagram showing the procedure executed by the protocol serializer 10 on target data packets after the procedure in FIG. 10. The protocol serializer 10 sequentially receives packets of target data (the target data 1 to 5 in FIG. 11) sent from the cache controller 11 and stores them in the transmission buffer G in the drive transmission/reception buffer D.

Furthermore, each time the protocol serializer 10 receives a target data packet in the transmission buffer G, the protocol serializer 10 identifies the transmission buffer I in the transmission destination server transmission/reception buffer E based on the server number contained in the target data packet (FIG. 9). The protocol serializer 10 deletes the integrated packet ID and server number of target data packets stored in the transmission buffer G and retrieves them in the FIFO manner. The protocol serializer 10 sends the target data retrieved in the FIFO manner to the identified transmission destination transmission buffer I to store them in the transmission buffer I. For example, when the packet of target data 2 is received in the reception buffer G, the packet is sent to the transmission destination transmission buffer 13 after the integrated packet ID and server number are deleted.

Furthermore, the protocol serializer 10 retrieves the target data packets stored in the transmission buffer I in the FIFO manner and sends them to the server A corresponding to the transmission buffer 1 via the server interface B (FIG. 1).

For example, since the packet of target data 2 contains the server number indicating the server A3, the target data 2 are sent to the transmission buffer 13 corresponding to the server A3 and then sent to the server A3 from the transmission buffer 13.

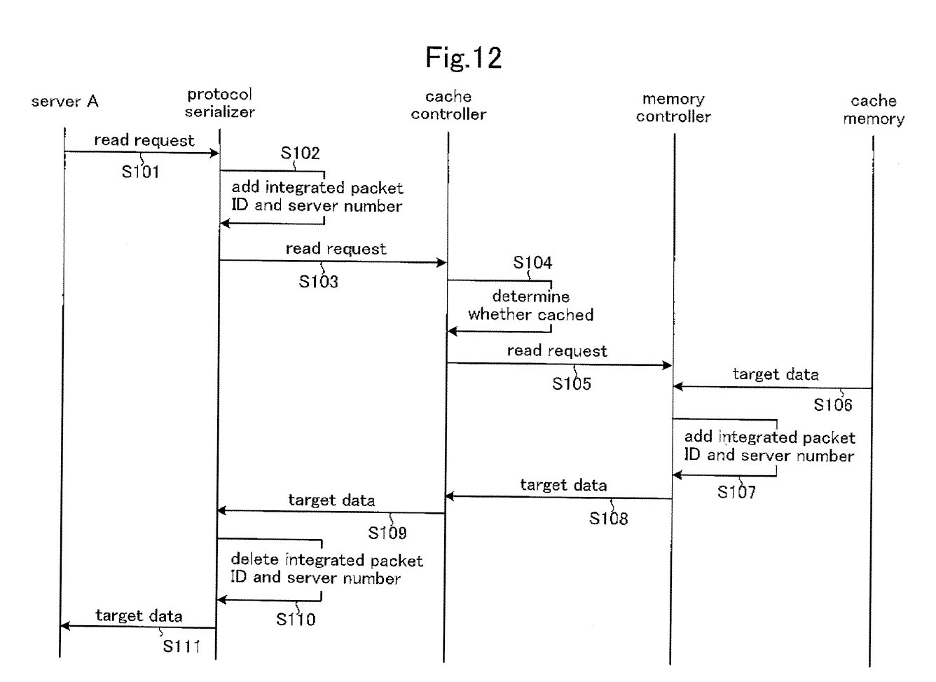

The entire operation of the communication system I will be described hereafter. First, operation in the case wherein target data corresponding to a read request are present in the cache memory 4 will be described with reference to FIG. 12.

The protocol serializer 10 makes the reception buffer H in the server transmission/reception buffer E receive and accumulate a read request packet sent from the server A (Step S101).

Then, the protocol serializer 10 retrieves the read request packet from the reception buffer H, adds an integrated packet ID and server number thereto, and stores the packet in the reception buffer F in the drive transmission/reception buffer I) (Step S102).

Then, the protocol serializer 10 retrieves the read request packet from the reception buffer F in the FIFO manner and sends it to the cache controller 11 (Step S103).

The main controller 20 in the cache controller 11 makes reference to the cache table (FIG. 7) and determines whether the target data corresponding to the read request are present in the cache memory 4 (whether they are cached) (Step S104). If the target data are present in the cache memory 4 (Step S104; YES), the main controller 20 sends the read request packet to the memory controller 12 (Step S105).

According to the contents of the read request packet, the memory controller 12 reads the target data from the cache memory 4 (Step S106).

Then, the memory controller 12 adds an integrated packet number and server number to the target data read in the Step S106 to generate a target data packet (Step S107) and sends the target data packet to the cache controller 11 (Step S108).

The cache controller 11 sends the target data packet to the protocol serializer 10 (Step S109).

The protocol serializer 10 receives and stores the target data packet in the transmission buffer G in the drive transmission/reception buffer D. The protocol serializer 10 identifies the transmission buffer I of the transmission destination of the target data packet and deletes the integrated packet ID and server number from the target data packet (Step S110).

The protocol serializer 10 sends the target data stored in the transmission buffer G to the transmission buffer I of the identified transmission destination and then sends the target data to the server A corresponding to the transmission buffer I (Step S111).

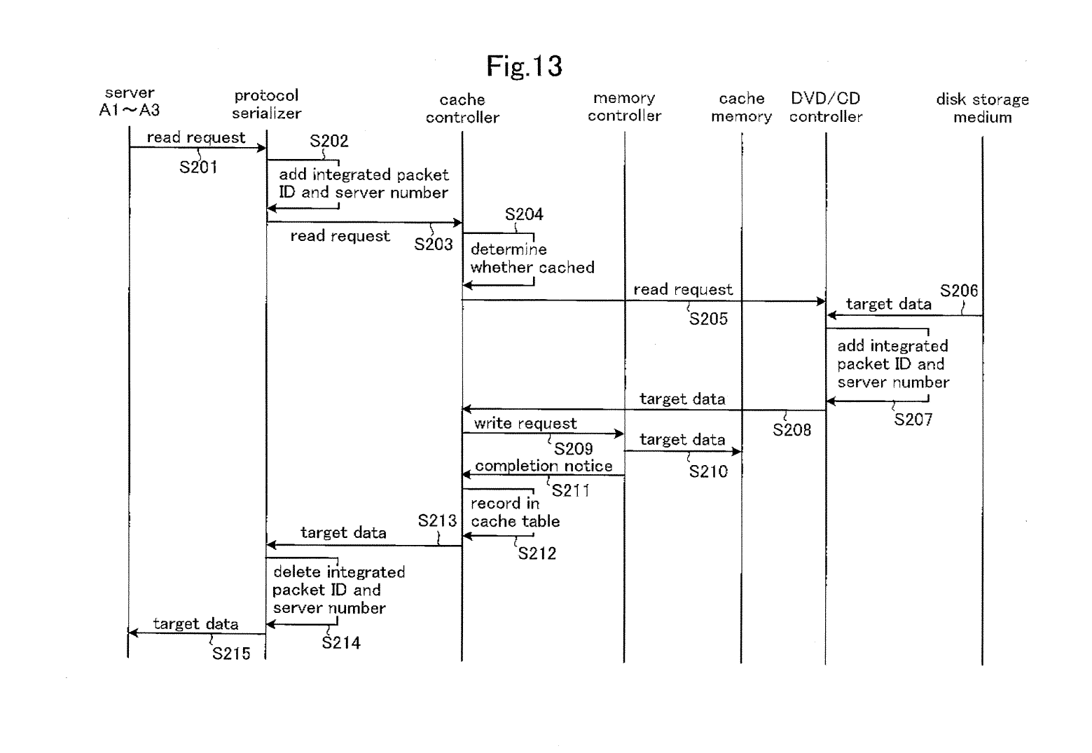

Operation in the case wherein target data corresponding to a read request are not written in the cache memory 4 will be described below with reference to FIG. 13.

In the operation shown in FIG. 13, after Steps S201 to S203 similar to the Steps S101 to S103 are executed, in Step S204 corresponding to the Step S104, the main controller 20 determines that the target data corresponding to a read request are not present in the cache memory 4 (not cached) (Step S204; NO), and sends the read request packet to the DVD/CD controller 13 (Step S205).

The DVD/CD controller 13 reads the target data from the disc storage medium K according to the contents of the read request packet (Step S206).

Then, the DVD/CD controller 13 adds an integrated packet ID and server number to the target data read in the Step S206 to generate a target data packet (Step S207) and sends the target data packet to the cache controller 11 (Step S208).

The cache controller 11 sends the packet received in the Step S208 to the memory controller 12 as a write request (Step S209).

The memory controller 12 writes the data in the cache memory 4 according to the contents of the write request (Step S210) and, after the writing is completed, sends a completion notice to the memory controller 11 (Step S211).

Receiving the completion notice, the cache controller 11 records information indicating the completion of writing the target data in the cache table (Step 212).

Then, in response to the completion of recording in the cache table, the cache controller 11 sends the target data packet received in the Step S208 to the protocol serializer 10 (Step S213). Then, Steps S214 and 215 similar to the Steps S110 and S111 are executed.

In the communication device 5 of this embodiment, read requests sent from the servers A1 to A3 are serialized and it is determined whether the target data corresponding to the read requests are present in the cache memory 4 in the order of serialized read requests. If present, the target data are acquired from the cache memory 4 and sent to a server A that is the transmission source of the read request corresponding to the target data. Consequently, the servers A to A3 are allowed to access the data stored on the disc storage medium K simultaneously, reducing the processing time to install target data onto the servers A1 to A3.

Furthermore, the cache memory 4 has a capacity equal to or larger than the maximum capacity of a disc storage medium K inserted in the DVD/CD drive. All data stored on the disc storage medium K can be written in the cache memory 4. Therefore, regardless of which data on the disc storage medium K are requested, the target data can be sent to the server A in a short time.

The present invention is not confined to the above embodiment and various modifications can be made without departing from the scope of the present invention.

For example, the communication device 5 may comprise a cache memory 4.

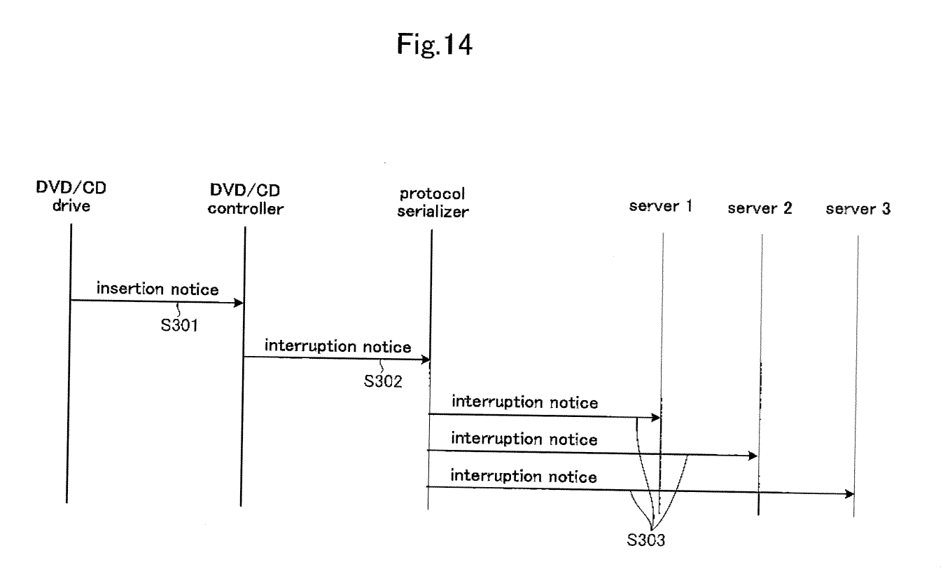

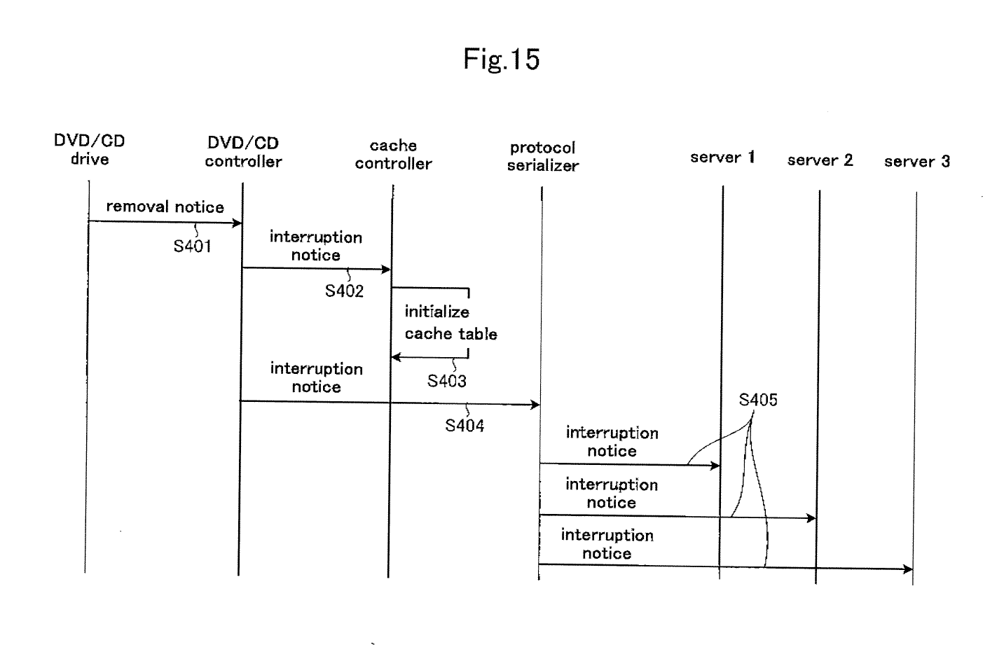

Furthermore, it is possible that the communication device 5 sends an interruption notice to the servers A1 to A3 when a disc storage medium K is inserted in the DVD/CD drive 3 or when the disc storage medium K is removed from the DVD/CD drive 3 and, receiving the interruption notice, the servers A1 to A3 are enabled or disabled to send a read request packet. In this way, the servers A1 to A3 and communication device 5 communicate after it becomes possible to read data stored on a disc storage medium K. The target data can be sent to the servers A1 to A3 immediately after a read request. Wasteful communication between the servers A1 to A3 and communication device 5 can be eliminated. The entire operation of the communication system 1 in such a case will be described with reference to FIGS. 14 and 15.

FIG. 14 is a chart for explaining the entire operation of the communication system 1 when a disc storage medium K is inserted in the DVD/CD drive 3.

With a disc storage medium K being inserted, the DVD/CD drive 3 sends an insertion notice indicating insertion of a disc storage medium K to the DVD/CD controller 13 (Step S301).

Receiving the insertion notice, the DVD/CD controller 13 sends an interruption notice to the protocol serializer 10 (Step S302). The protocol serializer 10 further sends the interruption notice to the servers A1 to A3 (Step S303). Receiving the interruption notice, the servers A1 to A3 are enabled to send a read request to packet the communication device 5.

FIG. 15 is a chart for explaining the entire operation of the communication system 1 when the disc storage medium K is removed from the DVD/CD drive 3.

With the disc storage medium K being removed, the DVD/CD drive 3 sends a removal notice indicating removal of the disc storage medium K to the DVD/CD controller 13 (Step S401).

Receiving the removal notice, the DVD/CD controller 13 sends an interruption notice to the cache controller 11 (Step S402).

Receiving the interruption notice, the cache controller 11 initializes the cache table (FIG. 7) (Step S403). More specifically, the cache controller 11 changes all cached flags in the cache table to “x.” Here, receiving the interruption notice, the cache controller 11 may delete all data in the cache memory 4 for initialization. In this way, the cache memory 4 is used as a region where data stored on a disc storage medium K are written only when the disc storage medium K is inserted.

Receiving the removal notice, the DVD/CD controller 13 sends an interruption notice to the protocol serializer 10 (Step S404). The protocol serializer 10 further sends the interruption notice to the servers A1 to A3 (Step S405).

Unlike the above embodiment, the drive address and cache address in the cache table (FIG. 7) are not necessarily be the same and may be different addresses correspond to each other on a one-to-one basis. In such a case, for determining whether target data are present in the cache memory, the main controller 20 identifies the row having a drive address equal to the read address in the read request packet and determines whether the cached flag of that row is “o.” The write request (FIG. 10) sent to the memory controller 12 contains the cache address range shown in the row of the cache table used for determining whether the target data are present/absent. The memory controller writes the target data in the cache address range.

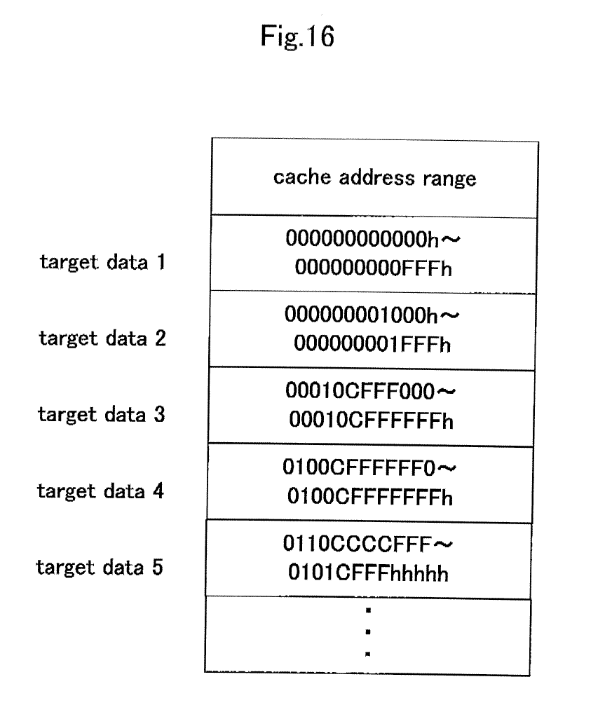

Furthermore, the cache table can be modified as shown in FIG. 16. In the cache table in FIG. 16, the cached flag and drive address range in the cache table in FIG. 7 are eliminated.

When the cache table in FIG. 16 is used, the write request (FIG. 10) sent to the memory controller 12 contains the read address in a read request packet (FIG. 5) and the address in the cache memory 4 at which the target data are written is set to the read address. Furthermore, the completion notice contains the read address as the address in the cache memory 4 at which the target data are written. Each time the main controller receives a completion notice, the main controller records the read address in the cache address range of the cache table (FIG. 16). The main controller 20 determines whether the target data are present in the cache memory 4 depending on whether the read address in the read request packet is recorded in the cache table (FIG. 16).

Furthermore, it is possible that the communication device 5 is provided with a detection part detecting whether it is possible to read data from a disc storage medium K, starts writing data stored on the disc storage medium K in the cache memory 4 when the detection part detects that it is possible to read data, and starts accepting a read request and obtaining the target data corresponding to the read request from the cache memory 4 after all data stored on the disc storage medium K are written in the cache memory 4. In such a case, no cache table is provided in the cache controller 11 and the procedure to determine whether the target data are present in the cache memory 4 is eliminated. Therefore, the cache controller 11 can significantly be simplified in structure.

Alternatively, it is possible to start writing data in the cache memory 4 and, in parallel, write the target data in response to reception of a read request after the detection part detects that it is possible to read data. In such a case, all data on the disc storage medium K are written in the cache memory 4 in a given time period even if no read request is sent from the servers A1 to A3. Therefore, it is more likely that the target data read from the cache memory 4 are sent to the servers A1 to A3. Then, the time to install the target data can be reduced.

The number of servers A provided to the communication system 1 is not limited to three as in the above embodiment and any number of servers can be provided.

The number of DVD/CD drive 3 provided to the communication system 1 is not limited to one as in the above embodiment and any number of DVD/CD drives can be provided. In such a case, the read request packet (FIGS. 2 and 5) and cache table contain information specifying the DVD/CD drive 3 in which the target data are stored and such information is used to determine whether the target data are written in the cache memory 4.

In addition, the above-described hardware configuration and flowchart is given by way of example and any changes and modifications can be made.

The communication device 5 can be realized by a conventional computer system. For example, the computer programs for executing the above-described operation are stored and distributed on a computer-readable recording medium (flexible disc, CD-ROM, DVD-ROM, etc.) and installed on a computer to configure the communication device 5 executing the above-described procedures. Alternatively, the computer programs can be stored in a storage device of a server on a communication network such as the Internet and downloaded on a conventional computer system to configure the parts of the communication device 5.

The above embodiment will partly or entirely be described as in the following subjunction, but not limited thereto.

(Subjunction 1)

A communication device, comprising:

a receiver receiving read requests for data stored on a disc storage medium from multiple servers;

a serializer arranging the read requests received by the receiver a processing order;

a writer writing data stored on the disc storage medium in a cache memory;

a determiner determining whether the target data corresponding to the read requests are present in the cache memory in the order of the read requests arranged by the serializer;

an information acquirer acquiring the target data from the cache memory when the determiner determines that the target data are present in the cache memory, and acquiring the target data from the disc storage medium when the determiner determines that the target data are not present in the cache memory; and

a transmitter sending the target data acquired by the information acquirer to the server of the transmission source of the read request corresponding to the target data.

(Subjunction 2)

The communication device according to Subjunction 1, wherein:

the serializer serializes the read requests by storing the read requests received by the receiver in the order of reception, retrieving the stored read requests in the first-in first-out manner, and sending them to the determiner.

(Subjunction 3)

The communication device according to Subjunction 1 or 2, wherein:

the writer writes the target data acquired by the information acquirer in the cache memory when the determiner determines that the target data are not present in the cache memory.

(Subjunction 4)

The communication device according to Subjunction 1 or 2, wherein:

the writer writes all data stored on the disc storage medium in the cache memory; and

the information acquirer acquires the target data from the cache memory after the writer writes all data stored on the disc storage medium in the cache memory.

(Subjunction 5)

The communication device according to Subjunction 4, further comprising:

a detector detecting whether it is possible to read data from the disc storage medium,

wherein the writer starts writing the target data stored on the disc storage medium in the cache memory when the detector detects that it is possible to read data.

(Subjunction 6)

The communication device according to any of Subjunction 1 to 5, further comprising:

a detector detecting whether it is possible to read data from the disc storage medium,

wherein the writer deletes all of the target data written in the cache memory when the detector detects that it is impossible to read data.

(Subjunction 7)

The communication device according to any of Subjunction 1 to 6, wherein:

the cache memory has a capacity equal to or larger than the capacity of the disc storage medium.

(Subjunction 8)

A communication method, comprising:

a reception step of receiving read requests for data stored on a disc storage medium from multiple servers;

a serialization step of arranging the read requests received in the reception step in a processing order;

a writing step of writing data stored on the disc storage medium in a cache memory;

a determination step of determining whether the target data corresponding to the read requests are present in the cache memory in the order of the read requests arranged in the serialization step;

an information acquisition step of acquiring the target data from the cache memory when it is determined that the target data are present in the cache memory in the determination step, and acquiring the target data from the disc storage medium when it is determined that the target data are not present in the cache memory; and

a transmission step of sending the target data acquired in the information acquisition step to the server of the transmission source of the read request corresponding to the target data.

(Subjunction 9)

The communication method according to Subjunction 8, wherein:

in the serialization step, the read requests are serialized by storing the read requests received in the reception step in the order of reception, retrieving the stored read requests in the first-in first-out mariner, and sending them to the executer of the determination step.

(Subjunction 10)

The communication method according to Subjunction 8 or 9, wherein:

in the writing step, the target data acquired in the information acquisition step are written in the cache memory when it is determined that the target data are not present in the cache memory in the determination step.

(Subjunction 11)

The communication method according to Subjunction 8 or 9, wherein:

in the writing step, all data stored on the disc storage medium are written in the cache memory; and

in the information acquisition step, the target data are acquired from the cache memory after all data stored on the disc storage medium are written in the cache memory in the writing step.

(Subjunction 12)

The communication device according to Subjunction 11, further comprising:

a detection step of detecting whether it is possible to read data from the disc storage medium,

wherein in the writing step, the writing of the target data stored on the disc storage medium in the cache memory starts after it is detected that it is possible to read data in the detection step.

(Subjunction 13)

The communication device according to any of Subjunction 8 to 12, further comprising:

a detector detecting whether it is possible to read data from the disc storage medium,

wherein the writer deletes all of the target data written in the cache memory when the detector detects that it is impossible to read data.

(Subjunction 14)

A computer-readable recoding medium storing programs that allow a computer to function as:

a receiver receiving read requests for data stored on a disc storage medium from multiple servers;

a serializer arranging the read requests received by the receiver in a processing order;

a writer writing data stored on the disc storage medium in a cache memory;

a determiner determining whether the target data corresponding to the read requests are present in the cache memory in the order of the read requests arranged by the serializer;

an information acquirer acquiring the target data from the cache memory when the determiner determines that the target data are present in the cache memory, and acquiring the target data from the disc storage medium when the determiner determines that the target data are not present in the cache memory; and

a transmitter sending the target data acquired by the information acquirer to the server of the transmission source of the read request corresponding the target data.

The present invention is suitable for a system controlling access to a data storage medium.

Having described and illustrated the principles of The present application by reference to one preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

What is claimed is:

1. A communication device, comprising:
a receiver receiving read requests for data stored on a disc storage medium from multiple servers;
a serializer arranging said read requests received by the receiver in a processing order;
a writer writing data stored on said disc storage medium in a cache memory;
a determiner determining whether the target data corresponding to said read requests are present in said cache memory in the order of said read requests arranged by said serializer;
an information acquirer acquiring said target data from said cache memory when said determiner determines that said target data are present in said cache memory, and acquiring said target data from said disc storage medium when said determiner determines that said target data are not present in said cache memory; and
a transmitter sending the target data acquired by said information acquirer to the server of the transmission source of said read request corresponding to the target data.

2. The communication device according to claim 1, wherein:
said serializer arranges said read requests in a processing order by storing the read requests received by said receiver in the order of reception, retrieving the stored read requests in the first-in first-out manner, and sending them to said determiner.

3. The communication device according to claim 1, wherein:
said writer writes said target data acquired by said information acquirer in said cache memory when said determiner determines that said target data are not present in said cache memory.

4. The communication device according to claim 2, wherein:
said writer writes said target data acquired by said information acquirer in said cache memory when said determiner determines that said target data are not present in said cache memory.

5. The communication device according to claim 1, wherein;
said writer writes all data stored on said disc storage medium in said cache memory; and
said information acquirer acquires said target data from said cache memory after said writer writes all data stored on said disc storage medium in said cache memory.

6. The communication device according to claim 2, wherein:
said writer writes all data stored on said disc storage medium in said cache memory; and
said information acquirer acquires said target data from said cache memory after said writer writes all data stored on said disc storage medium in said cache memory.

7. The communication device according to claim 5, further comprising:
a detector detecting whether it is possible to read data from said disc storage medium,
wherein said writer starts writing said target data stored on said disc storage medium in said cache memory when said detector detects that it is possible to read data.

8. The communication device according to claim 6, further comprising:
a detector detecting whether it is possible to read data from said disc storage medium,
wherein said writer starts writing said target data stored on said disc storage medium in said cache memory when said detector detects that it is possible to read data.

9. The communication device according to claim 1, further comprising:
a detector detecting whether it is possible to read data from said disc storage medium,
wherein said writer deletes all of said target data written in said cache memory when said detector detects that it is impossible to read data.

10. The communication device according to claim 2, further comprising:
a detector detecting whether it is possible to read data from said disc storage medium,
wherein said writer deletes all of said target data written in said cache memory when said detector detects that it is impossible to read data.

11. The communication device according to claim 3, further comprising:
a detector detecting whether it is possible to read data from said disc storage medium,
wherein said writer deletes all of said target data written in said cache memory when said detector detects that it is impossible to read data.

12. The communication device according to claim 5, further comprising:
a detector detecting whether it is possible to read data from said disc storage medium,
wherein said writer deletes all of said target data written in said cache memory when said detector detects that it is impossible to read data.

13. The communication device according to claim 7, wherein:
said writer deletes all of said target data written in said cache memory when said detector detects that it is impossible to read data.

14. The communication device according to claim 1, wherein:
said cache memory has a capacity equal to or larger than the capacity of said disc storage medium.

15. The communication device according to claim 2, wherein:
said cache memory has a capacity equal to or larger than the capacity of said disc storage medium.

16. The communication device according to claim 3, wherein:
said cache memory has a capacity equal to or larger than the capacity of said disc storage medium.

17. The communication device according to claim 5, wherein:
said cache memory has a capacity equal to or larger than the capacity of said disc storage medium.

18. The communication device according to claim 9, wherein:
said cache memory has a capacity equal to or larger than the capacity of said disc storage medium.

19. A communication method, comprising:
a reception step of receiving read requests for data stored on a disc storage medium from multiple servers;
a serialization step of arranging said read requests received in the reception step in a processing order;
a writing step of writing data stored on said disc storage medium in a cache memory;
a determination step of determining whether the target data corresponding to said read requests are present in said cache memory in the order of said read requests arranged by said serializer;
an information acquisition step of acquiring said target data from said cache memory when it is determined that said target data are present in said cache memory in said determination step, and acquiring said target data from said disc storage medium when it is determined that said target data are not present in said cache memory; and
a transmission step of sending the target data acquired in said information acquisition step to the server of the transmission source of said read request corresponding to the target data.

20. A computer-readable recoding medium storing programs that allow a computer to function as:
a receiver receiving read requests for data stored on a disc storage medium from multiple servers;
a serializer arranging said read requests received by the receiver in a processing order;
a writer writing data stored on said disc storage medium in a cache memory;
a determiner determining whether the target data corresponding to said read requests are present in said cache memory in the order of said read requests arranged by said serializer;
an information acquirer acquiring said target data from said cache memory when said determiner determines that said target data are present in said cache memory, and acquiring said target data from said disc storage medium when said determiner determines that said target data are not present in said cache memory; and
a transmitter sending the target data acquired by said information acquirer to the server of the transmission source of said read request corresponding to the target data.
